(19) United States
(12) Patent Application Publication
(10) Pub. No.: US 2021/0366443 A1
(43) Pub. Date: Nov. 25, 2021

(54) DISPLAYING METHOD AND PROCESSOR

(71) Applicant: NOVATEK Microelectronics Corp., Hsinchu (TW)

(72) Inventors: Yung-Cheng TSAI, Hsinchu City (TW); Feng-Ting PAI, Hsinchu City (TW)

(21) Appl. No.: 16/882,537

(22) Filed: May 24, 2020

(51) Int. Cl. G09G 5/395; G09G 5/373; G09G 3/20; G06F 3/147

(52) U.S. Cl. CPC G09G 5/395; G09G 5/373; G09G 2340/0464; G06F 3/147; G09G 2340/14; G09G 3/20

(57) ABSTRACT

A displaying method applicable for a displaying panel including a plurality of pixel circuits is disclosed. The displaying method includes: receiving a plurality of input data, wherein the plurality of input data comprise a curve; converting a plurality of coordinates of the plurality of input data into a plurality of real coordinates according to the plurality of pixel circuits; applying anti-aliasing processing to the plurality of input data; and displaying the plurality of input data by the plurality of pixel circuits.

### BACKGROUND

### Field of Invention

The invention relates to a displaying method and a processor. More particularly, the invention relates to a displaying method and a processor for displaying a curve on the panel.

### Description of Related Art

Due to different requirements of the display, different curves need to be drawn on the panel. In some cases, the shape of the panel is composed of curves, such as watches, camera holes, and so on. The traditional design is improved by the process side. With the traditional design, the display effect is improved, but the production cost and process difficulty is also increased.

### SUMMARY

An embodiment of this disclosure is to provide a displaying method applicable for a displaying panel including a plurality of pixel circuits. The displaying method includes: receiving a plurality of input data, wherein the plurality of input data comprise a curve; converting a plurality of coordinates of the plurality of input data into a plurality of real coordinates according to the plurality of pixel circuits; applying anti-aliasing processing to the plurality of input data; and displaying the plurality of input data by the plurality of pixel circuits.

Another embodiment of this disclosure is to provide a processor coupled to a displaying panel including a plurality of pixel circuits. The processor is configured to convert several coordinates of several input data into several real coordinates according to the several pixel circuits, to apply anti-aliasing processing to the several input data, and to transmit the several input data to the displaying panel for the displaying panel to display the several input data transmitted from the processor. The displaying panel includes a boundary, in which the several pixel circuits are at one side of the boundary, and the boundary includes a curve.

Another embodiment of this disclosure is to provide a processor coupled to a displaying panel comprising several pixel circuits, in which the processor is configured to convert several coordinates of several input data into several real coordinates according to the several pixel circuits, to apply anti-aliasing processing to a curve of the several input data, and to transmit the several input data to the displaying panel for the displaying panel to display the several input data transmitted from the processor. The displaying panel includes a curve. A plurality of first sub pixel circuits of the plurality of pixel circuits are at one side of the curve. A plurality of a first sub pixel circuits of the plurality of pixel circuits are located at a first display area, in which the first display area is located at one side of the curve. A plurality of second sub pixel circuits of the plurality of pixel circuits are located at a second display area, wherein the second display area is located at another side of the curve.

Therefore, according to the technical concept of the present invention, embodiments of this disclosure are to provide a displaying method and a processor. By converting the coordinates of the input data into the real coordinates of the pixel circuits, and applying anti-aliasing processing to the input data, the curve may be displayed more smoothly without increasing the production cost and the process difficulty.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating a displaying device according to some embodiments of the present disclosure.

FIG. 2 is a schematic diagram illustrating a displaying panel according to some embodiments of the present disclosure.

FIG. 3 is a flowchart of a displaying method in accordance with some embodiments of the present disclosure.

FIG. 4 is a schematic diagram illustrating several input data with several coordinates according to some embodiments of the present disclosure.

FIG. 5 is a schematic diagram illustrating several input data with several real coordinates according to some embodiments of the present disclosure.

FIG. 6 is a schematic diagram illustrating a portion of the displaying panel as illustrated in FIG. 2 according to some embodiments of the present disclosure.

FIG. 7 is a schematic diagram illustrating another portion of the displaying panel as illustrated in FIG. 2 according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

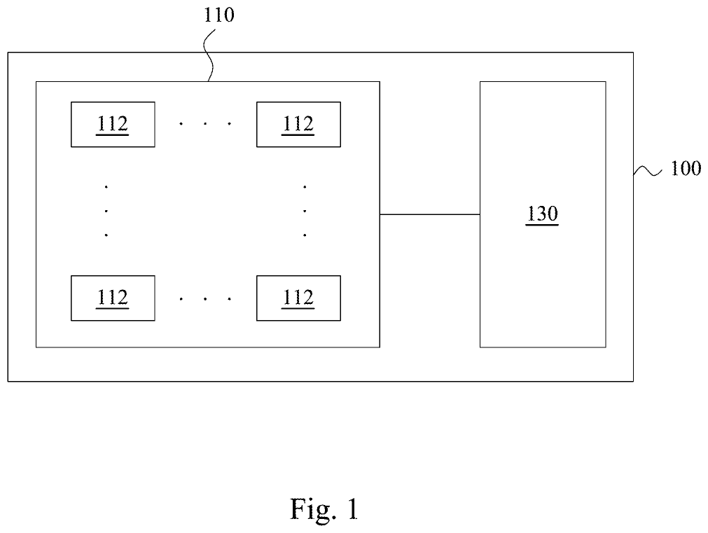

Reference is made to FIG. 1. FIG. 1 is a schematic diagram illustrating a displaying device 100 according to some embodiments of the present disclosure. As illustrated in FIG. 1, the displaying device 100 includes a displaying panel 110 and a processor 130. The displaying panel 110 is coupled to the processor 130. The displaying panel 110 includes several pixel circuits 112. It should be noted that, the displaying device as illustrated in FIG. 1 is for illustrative only, and the embodiments of the present disclosure are not limited thereto.

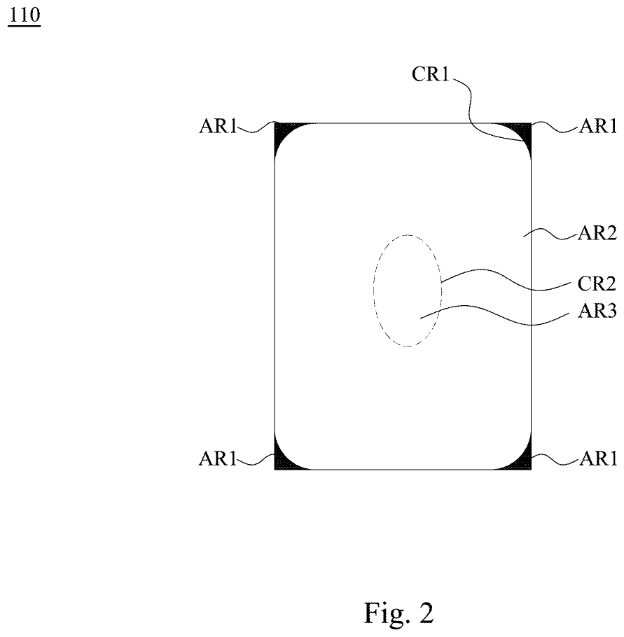

Reference is made to FIG. 2. FIG. 2 is a schematic diagram illustrating a displaying panel 110 according to some embodiments of the present disclosure. As illustrated in FIG. 2, the displaying panel 110 includes display areas AR1, AR2 and AR3. The display area AR1 does not display images, the display area AR2 displays images, and the display area AR3 displays the fingerprint detection image. The display area AR1 and the display area AR2 are separated by the curve CR1, and the display area AR2 and the display area AR3 area are separated by the curve CR2.

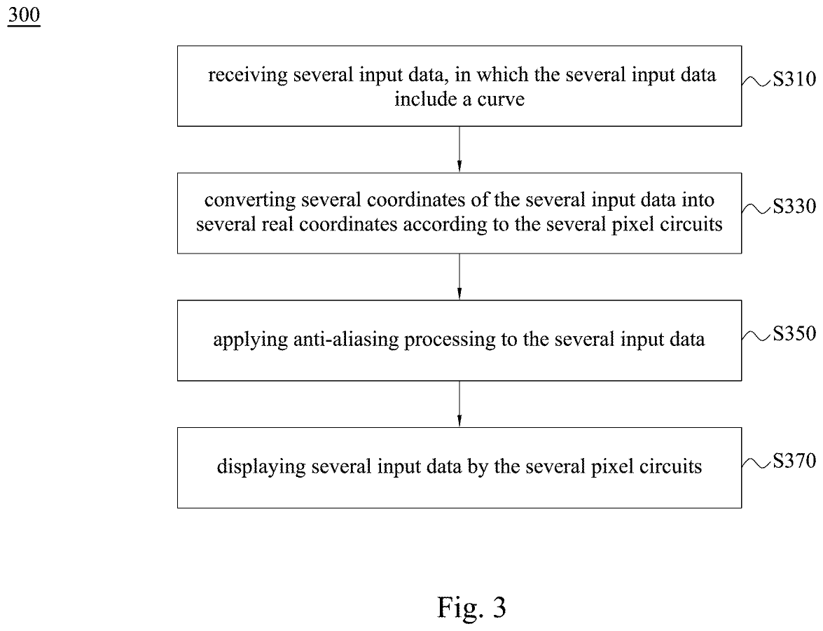

Reference is made to FIG. 3. FIG. 3 is a flowchart of a displaying method 300 suitable to be applied on the displaying device 100 in FIG. 1, in accordance with some embodiments of the present disclosure.

Details of the present disclosure are described in the paragraphs below with reference to a displaying method in FIG. 3, in which FIG. 3 is a flowchart of a displaying method 300 suitable to be applied on the displaying device 100 in FIG. 1, in accordance with some embodiments of the present disclosure. However, the present disclosure is not limited to the embodiment below.

In addition, it should be noted that in the operations of the following displaying method, no particular sequence is required unless otherwise specified. Moreover, the following operations also may be performed simultaneously or the execution times thereof may at least partially overlap.

Furthermore, the operations of the following displaying method may be added to, replaced, and/or eliminated as appropriate, in accordance with various embodiments of the present disclosure.

Reference is made to FIGS. 1, 2 and 3. The displaying method 300 includes the operations below.

In operation S310, several input data are received, in which the several input data include a curve. In some embodiments, operation S310 may be operated by the processor 130 as illustrated in FIG. 1. For example, the processor 130 receives several input data for displaying images on the displaying panel 110, and the input data include the input data for the curves CR1 and CR2 as illustrated in FIG. 2.

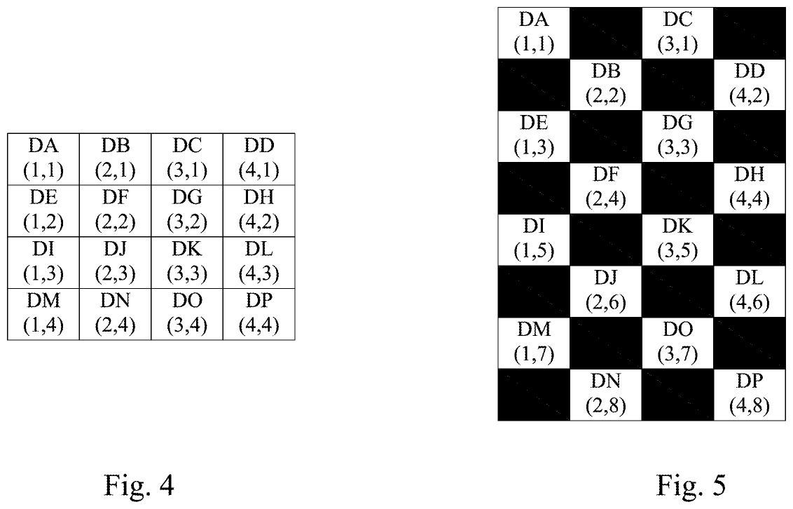

Reference is made to FIG. 4. FIG. 4 is a schematic diagram illustrating several input data DA to DP with several coordinates according to some embodiments of the present disclosure. It should be noted that, the input data DA to DP shown in FIG. 4 is for illustrative purposes only, and the embodiments of the present disclosure are not limited thereto.

In operation S330, several coordinates of the several input data are converted into several real coordinates according to the several pixel circuits. In some embodiments, the operation S330 may be operated by the processor 130 as illustrated in FIG. 1. Reference is made to FIG. 4 and FIG. 5 at the same time.

As shown in FIG. 4, each of the input data includes a coordinate. In detail, the coordinate of the input data DA is (1,1), the coordinate of the input data DB is (2,1), the coordinate of the input data DC is (3,1), and so on. FIG. 5 is a schematic diagram illustrating several input data DA to DP with several real coordinates according to some embodiments of the present disclosure. The real coordinates as shown in FIG. 5 are converted from the coordinates as shown in FIG. 4 according to the real coordinates of the several pixel circuits 112 as shown in FIG. 1. In detail, the coordinate of the input data DB is converted from (2,1) to the real coordinate (2,2), the coordinated of the input data DD is converted from (4,1) to the real coordinate (4,2), and so on.

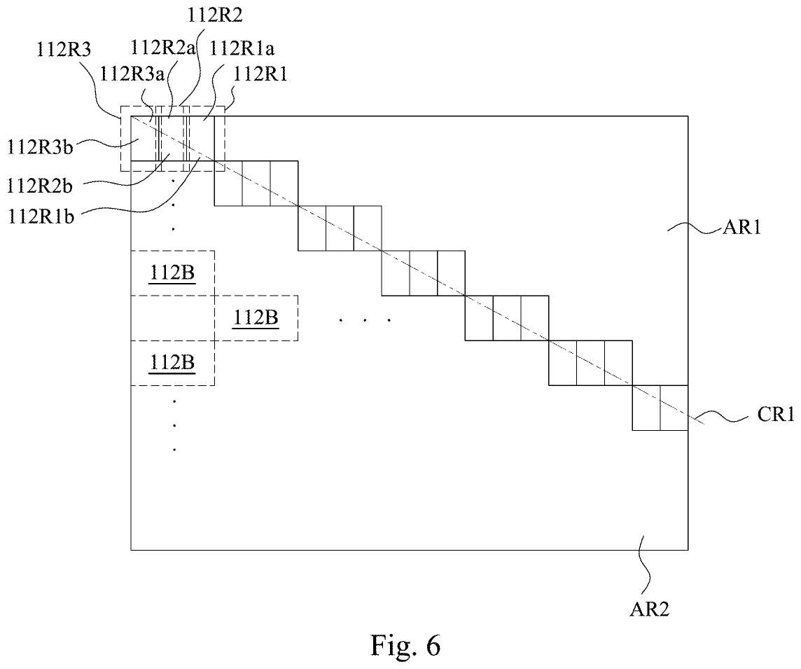

Reference is made to FIG. 6. FIG. 6 is a schematic diagram illustrating a portion of the displaying panel 110 as illustrated in FIG. 2 according to some embodiments of the present disclosure.

As illustrated in FIG. 6, the pixel circuits 112 illustrated in FIG. 1 includes sub pixel circuits 112B, 112R1 to 112R3. The sub pixel circuits 112B are the pixel circuits which located at the display area AR2. The display area AR1 does not include any pixel circuits.

In some embodiments, after determining the boundary, the processor 130 further determines part of the several input data DA to DP as first data, in which the first data are displayed at one side of the curve. The processor 130 further determines part of the several input data DA to DP as second data, in which the second data are displayed at another side of the curve.

Reference is made to FIG. 6. For example, the part of the several input data DA to DP displayed at the sub pixel circuits 112B are determined as the first data. Since the display area AR1 does not include any sub pixel circuits, none of the input data DA to DP is determined as the second data.

In some embodiments, the processor 130 further determines a first pixel value of the first data and a second pixel value of the second data. In some embodiments, when none of the sub pixel circuits exits, the pixel value is determined to be 0.

In operation S350, anti-aliasing processing is applied to the several input data. In some embodiments, the operation S350 may be operated by the processor 130 as illustrated in FIG. 1. In some embodiments, several third data are configured to display the curve. The processor 130 further blends the first pixel value and the second pixel value so as to generate several third pixel values of the third data, and the third data are to be displayed at the sub pixel circuits 112R1 to 112R3.

As illustrated in FIG. 6, in some embodiments, the sub pixel circuit 112R1 to 112R3 includes a first sub area and a second sub area respectively. The first sub area and the second sub area are separated by the curve CR1. The first sub areas are located at the display area AR2, and the second area are located at the display area AR1.

In detail, the sub pixel circuit 112R1 includes sub areas 112R1a and 112R1b, the sub pixel circuit 112R2 includes sub areas 112R2a and 112R2b, and the sub pixel circuit 112R3 includes sub areas 112R3a and 112R3b.

In some embodiments, the processor 130 is further configured to blend the first pixel value and the second pixel value according to area sizes of the sub areas of the third sub pixel circuits. For example, assume that the input data displayed at the display area AR2 includes the first pixel value, and the display area AR1 includes the second pixel value, which is zero, in some embodiments, the proportion of the blended first pixel value is in proportion to the area size of the sub area located at the display area AR2, and the proportion of the blended second pixel value, which is 0, is in proportion to the area size of the sub area located at the display area AR1. In some embodiments, the area sizes are calculated by the processor 130 as illustrated in FIG. 1.

For example, assume that the display area AR2 includes the first pixel value, and the second pixel value of the display area AR1 is zero. Assume that the area sizes of the sub pixel circuits 112R1 to 112R3 are the same, since the area size of the sub area 112R3b is larger than the area size of the sub area 112R2b, and the area size of the sub area 112R2b is larger than the area size of the sub area 112R1b, the proportion of the first pixel value blended in the pixel value displayed at the sub pixel circuit 112R3 is larger than the proportion of the first pixel value blended in the pixel value displayed at the sub pixel circuit 112R2, and the proportion of the first pixel value blended in the pixel value displayed at the sub pixel circuit 112R2 is larger than the proportion of the first pixel value blended in the pixel value displayed at the sub pixel circuit 112R1.

It should be noted that, in the example mentioning above, the proportion of the first pixel value and the second pixel value are in relation to the area sizes of the sub areas. However, the embodiments of the present disclosure are not limited thereto.

Other parameters may be used when blending the first pixel value and the second pixel value. For example, In some embodiments, the distance between the center of the sub pixel circuit and the curve CR1 may be used as the parameter when blending the first pixel value and the second pixel value.

In operation S370, several input data are displayed by the several pixel circuits. In some embodiments, the operation S370 may be operated by the processor 130 as illustrated in FIG. 1. In some embodiments, after determining the value and the coordinates of the first data, the second data, and the third data, the processor 130 displays the input data by the pixel circuits 112. In some embodiments, before displaying the input data, the processor 130 further sets a configuration of the first data, the second data, and the third data. The configuration includes voltages or gamma settings.

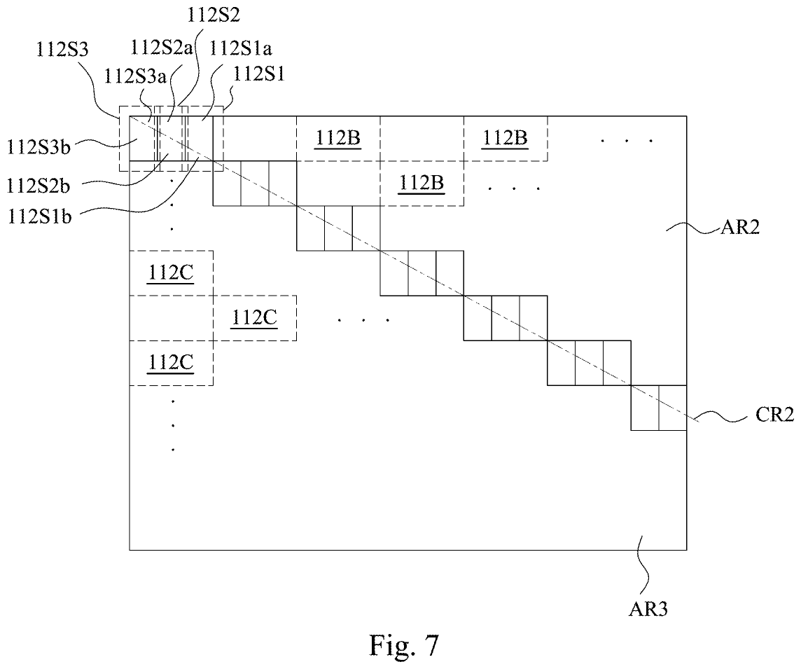

Reference is made to FIG. 7. FIG. 7 is a schematic diagram illustrating another portion of the displaying panel 110 as illustrated in FIG. 2 according to some embodiments of the present disclosure. Another example is made with the curve CR2. In this example, the sub pixel circuits 112S1 to 112S3 are configured to display the curve CR2. The pixel values to be displayed at the sub pixel circuits 112S1 to 112S3 are generated according to the pixel values of the display areas AR3 and AR2. As mentioning above, in some embodiments, when generating the third pixel values of the third sub pixel circuits, the area sizes of the sub areas 112S1a, 112S2a, 112S3a, 112S1b, 112S2b, and 112S3b are within consideration. In detail, as illustrated in FIG. 7, since the area size of the sub area 112S3b is larger than the area size of the sub area 112S3a, when generating the pixel value of the display circuit 112S3, the proportion of the pixel value of the display area AR3 is larger than the proportion of the pixel value of the display area AR2. That is, the larger the area size of the sub area located at the display area AR3, the larger is the proportion of the pixel value of the display area AR3 while generating the pixel value of the sub pixel circuits 112S1 to 112S3. Similarly, the larger the area size of the sub area located at the display area AR2, the larger is the proportion of the pixel value of the display area AR2 while generating the pixel value of the sub pixel circuits 112S1 to 112S3. In some embodiments, the displayed area AR3 is the finger print detection area, and the range of the finger print detection area may be adjusted.

The rest of the operations are similar to the displaying method 300 as mentioning above and will not be repeated here.

In some embodiments, the range of the data with anti-aliasing processing may be adjusted so as to adjust the smoothness/sharpness of the curve displayed.

In some embodiments, the input data include red, green, and blue pixel colors. Different pixel colors are given with different anti-aliasing proportion parameter. That is, the anti-aliasing proportion parameters of different pixel colors are different, and the color balance may be maintained. In some embodiments, the anti-aliasing proportion parameters are the proportions of the first pixel value.

In some embodiments, the processor 130 is configured to run or execute various software programs and/or sets of instructions to perform various functions to process data. In one embodiment, the processor 130 may be realized by an integrated circuit. In some embodiments, the processor 130 can be realized by, for example, one or more processors, such as central processors and/or microprocessors, but are not limited in this regard.

In some embodiments, the displaying panel 110 can be realized by, for example, a display, such as a liquid crystal display or an active matrix organic light emitting diode (AMOLED) display, but is not limited in this regard.

It may be known from the embodiments mentioning above, the embodiments of the present disclosure provide a displaying method and a processor. By converting the coordinates of the input data into the real coordinates of the pixel circuits, and applying anti-aliasing processing to the input data, the curve may be displayed more smoothly without increasing the production cost and the process difficulty. Moreover, by adjusting the range of the boundary area, the smoothness/sharpness of the curve displayed may be adjusted for better performance.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one unit from another. For example, a first unit could be termed a second element, and, similarly, a second unit could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A displaying method, applicable for a displaying panel comprising a plurality of pixel circuits, comprising:
receiving a plurality of input data, wherein the plurality of input data comprise a curve, and a plurality of first sub pixel circuits of the plurality of pixel circuits are configured to display the curve;
determining a plurality of first data of the plurality of input data, wherein the plurality of the first data are displayed at a first display area located at one side of the curve;
determining a plurality of second data of the plurality of input data, wherein the plurality of the second data are displayed at a second display area located at another side of the curve;
converting a plurality of coordinates of the plurality of input data into a plurality of real coordinates according to the plurality of pixel circuits;
applying anti-aliasing processing to the plurality of input data; and
displaying the plurality of input data by the plurality of pixel circuits;
wherein a smoothness/sharpness of the curve displayed may be adjusted by adjusting a range of a boundary area for anti-aliasing processing.

2. (canceled)

3. The displaying method of claim 1, further comprising:
determining a first pixel value of the plurality of first data; and
determining a second pixel value of the plurality of second data.

4. The displaying method of claim 3, further comprising:
determining a plurality of third data, wherein the plurality of third data comprise the curve; and
generating a plurality of third pixel values of the plurality of third data according to the first pixel value and the second pixel value.

5. The displaying method of claim 4, wherein each of the third data are displayed at one of a plurality of first sub pixel circuits of the plurality of pixel circuits, wherein the one of the plurality of first sub pixel circuits comprises a first sub area and a second sub area, wherein the displaying method further comprises:
calculating a first area size of the first sub area and a second area size of the second sub area, wherein the first sub area is located at the first display area, and the second sub area is located at the second display area; and
blending the first pixel value and the second pixel value according to the first area size and the second area size.

6. The displaying method of claim 4, further comprising:
setting a configuration of the plurality of first data; and
setting a configuration of the plurality of second data.

7. The displaying method of claim 3, wherein the first pixel value is 0.

8. A processor, coupled to a displaying panel comprising a plurality of pixel circuits, wherein the processor is configured to convert a plurality of coordinates of a plurality of input data into a plurality of real coordinates according to the plurality of pixel circuits, to apply anti-aliasing processing to the plurality of input data, and to transmit the plurality of input data to the displaying panel for the displaying panel to display the plurality of input data transmitted from the processor;
wherein the displaying panel comprises a curve, wherein a plurality of first sub pixel circuits of the plurality of pixel circuits are at one side of the curve;
wherein a plurality of second sub pixel circuits of the plurality of pixel circuits display the curve;
wherein a smoothness/sharpness of the curve displayed may be adjusted by adjusting a range of a boundary area for anti-aliasing processing.

9. (canceled)

10. The processor of claim 8, wherein the processor is further configured to determine a first pixel value of the plurality of first sub pixel circuits.

11. The processor of claim 10, wherein the processor is further configured to generate a plurality of second pixel values of the plurality of second sub pixel circuits.

12. The processor of claim 11, wherein the processor is further configured to generate the plurality of second pixel values according to a plurality of weight values of the plurality of second sub pixel circuits.

13. The processor of claim 12, wherein the plurality of weight values are relevant to an area size of the plurality of second sub pixel circuits located at the one side of the curve.

14. A processor, coupled to a displaying panel comprising a plurality of pixel circuits, wherein the processor is configured to convert a plurality of coordinates of a plurality of input data into a plurality of real coordinates according to the plurality of pixel circuits, to apply anti-aliasing processing to a curve of the plurality of input data, and to transmit the plurality of input data to the displaying panel for the displaying panel to display the plurality of input data transmitted from the processor,
wherein a plurality of a first sub pixel circuits of the plurality of pixel circuits are located at a first display area, wherein the first display area is located at one side of the curve;
wherein a plurality of a second sub pixel circuits of the plurality of pixel circuits are located at a second display area, wherein the second display area is located at another side of the curve;
wherein the processor is further configured to determine a plurality of first data of the plurality of input data, and to determine a plurality of second data of the plurality of input data;
wherein the plurality of first data are displayed at the first display area, and the plurality of second data are displayed at the second display area;
wherein a smoothness/sharpness of the curve displayed may be adjusted by adjusting a range of a boundary area for anti-aliasing processing.

15. (canceled)

16. The processor of claim 14, wherein the processor is further configured to determine a first pixel value of the plurality of first data, and to determine a second pixel value of the plurality of second data.

17. The processor of claim 16, wherein the plurality of pixel circuits comprise a plurality of third sub pixel circuits, wherein to the processor is further configured to blend the first pixel value and the second pixel value so as to generate a plurality of third data of the plurality of third sub pixel circuits.

18. The processor of claim 17, wherein the processor is further configured to blend the first pixel value and the second pixel value according to a first area size of a first sub area and a second area size of a second sub area of one of a plurality of the third sub pixel circuits, wherein the first sub area is located at the first display area, and the second sub area is located at the second display area.

19. The processor of claim 18, wherein a first weight value of the first pixel value blended is proportional to the first area size, and a second weight value of the second pixel value blended is proportional to the second area size.

20. The processor of claim 17, wherein the processor is further configured to set a configuration of the plurality of first data, and to set a configuration of the plurality of second data.
